(19) United States
(12) Patent Application Publication
(10) Pub. No.: US 2026/0011540 A1
(43) Pub. Date: Jan. 8, 2026

(54) Chromatograph Mass Spectrometry Data Processing Method and Chromatograph Mass Spectrometry Data Processing Apparatus

(71) Applicant: SHIMADZU CORPORATION, Kyoto-shi (JP)

(72) Inventors: Yuichiro FUJITA, Kyoto-shi (JP); Hiroaki KOZAWA, Kyoto-shi (JP); Yuriko NAKAKIMURA, Kyoto-shi (JP); Akira NISHIO, Kyoto-shi (JP); Yoshikatsu UMEMURA, Kyoto-shi (JP)

(21) Appl. No.: 19/258,377

(22) Filed: Jul. 2, 2025

(30) Foreign Application Priority Data
Jul. 5, 2024 (JP) 2024-108962

(51) Int. Cl. H01J 49/00; G01N 30/72; G01N 30/86

(52) U.S. Cl. CPC H01J 49/0036; G01N 30/7233; G01N 30/8631

(57) ABSTRACT

A first aspect of a chromatograph mass spectrometry data processing method according to the present invention is a chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a mass-to-charge ratio range as precursor ions for a predetermined mass-to-charge ratio range including a mass-to-charge ratio corresponding to the selected one MS1 peak, the method comprising a process of setting a peak threshold based on an intensity of the selected one MS1 peak, and a process of comparing an intensity of an MS2 peak appearing in the MS2 spectrum with the peak threshold, and determining that the MS2 spectrum is a chimeric MS2 spectrum when there is an MS2 peak having an intensity greater than the peak threshold.

### TECHNICAL FIELD

The present invention relates to a method and an apparatus for processing data obtained by chromatograph mass spectrometry.

### BACKGROUND ART

Chromatograph mass spectrometers are widely used to identify a plurality of components (compounds) contained in a sample. In a chromatograph mass spectrometer, a plurality of components contained in a sample are identified by separating the plurality of components for each retention time in a chromatograph in a preceding stage, and performing mass spectrometry for each retention time in a mass spectrometry unit in a subsequent stage. In particular, when a sample is considered to contain many components, a mass spectrometer capable of MSn analysis (n≥2) may be used as the mass spectrometry unit in order to perform component identification with higher accuracy.

When analyzing a sample that is considered to contain an enormous number of components, such as a biological sample like blood, comprehensive component identification is required in addition to high accuracy. Data Dependent Acquisition (DDA) is known as one of the analytical methods effective for comprehensive component identification.

In DDA, an MS1 spectrum is acquired by MS1 analysis for each retention time, an MS1 peak to be subjected to MS2 analysis is selected from the MS1 peaks appearing in the MS1 spectrum, and MS2 analysis is performed using ions having an m/z value (mass-to-charge ratio) corresponding to the selected MS1 peak as precursor ions to acquire an MS2 spectrum.

Some components contained in a sample include isotope elements. When a component including an isotope element is subjected to MS1 analysis, one type of ion is detected as a plurality of MS1 peaks for each molecular weight, and an MS1 spectrum is obtained in which the MS1 peaks are arranged at a predetermined mass-to-charge ratio interval (this group of peaks is called an isotope distribution). Therefore, in DDA, in order to increase the spectral intensity corresponding to the component to be analyzed, MS2 analysis may be performed using ions belonging to a mass-to-charge ratio range of several Da (typically 2 to 4 Da) including the isotope distribution on the MS1 spectrum as precursor ions (for example, see Patent Literature 1).

### CITATION LIST

### Patent Literature

[Patent Literature 1] Japanese Unexamined Patent Application Publication No. 2022-079364

### SUMMARY OF INVENTION

### Technical Problem

Conventionally, in DDA, since the mass-to-charge ratio range of precursor ions targeted in a single MS2 analysis is narrow, it has been assumed that the acquired MS2 spectrum originates from one type of ion, that is, one type of component, if isotopes are not distinguished. Based on this assumption, component identification is performed from the mass-to-charge ratio of the precursor ions and the mass-to-charge ratio of the productions.

However, when analyzing a sample that is considered to contain an enormous number of components, such as a biological sample like blood, it is often the case that a plurality of types of ions derived from different components are mixed in the above-mentioned mass-to-charge ratio range of several Da. In this specification, an MS2 spectrum that uses a plurality of types of ions derived from different components as precursor ions will be referred to as a chimeric MS2 spectrum. In other words, a chimeric MS2 spectrum is an MS2 spectrum in which MS2 spectra using each of a plurality of types of ions derived from different components as precursor ions are mixed.

Since the above-mentioned assumption does not hold for a chimeric MS2 spectrum, it is difficult to identify the original components from the chimeric MS2 spectrum. Further, it is not easy to determine whether an MS2 spectrum acquired by DDA is a chimeric MS2 spectrum just by looking at it. Therefore, if the MS2 spectrum is a chimeric MS2 spectrum, there is a risk of performing erroneous component identification. According to the inventor's experience, about 20% to 50% of the MS2 spectra obtained by a series of analyses for biological samples are chimeric MS2 spectra, and the influence of chimeric MS2 spectra on component identification by DDA is not negligible.

An object of the present invention is to provide a method for determining whether an MS2 spectrum acquired by DDA is a chimeric MS2 spectrum.

### Solution to Problem

A first aspect of the chromatograph mass spectrometry data processing method according to the present invention for solving the above problem is a chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to the mass-to-charge ratio range as precursor ions for a predetermined mass-to-charge ratio range including the mass-to-charge ratio corresponding to the selected one MS1 peak, the method comprising: a process of setting a peak threshold based on the intensity of the selected one MS1 peak; and a process of comparing the intensity of an MS2 peak appearing in the MS2 spectrum with the peak threshold, and determining that the MS2 spectrum is a chimeric MS2 spectrum when there is an MS2 peak having an intensity greater than the peak threshold.

A second aspect of the chromatograph mass spectrometry data processing method according to the present invention for solving the above problem is a chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to the mass-to-charge ratio range as precursor ions for a predetermined mass-to-charge ratio range including the mass-to-charge ratio corresponding to the selected one MS1 peak, the method comprising:
a process of setting a peak threshold based on the intensity of the selected MS1 peak; and
a process of comparing a total value of intensities of a plurality of MS2 peaks appearing in the MS2 spectrum with the peak threshold, and determining that the MS2 spectrum is a chimeric MS2 spectrum when the total value is greater than the peak threshold.

A first aspect of a chromatograph mass spectrometry data processing apparatus according to the present invention for solving the above problem comprises: an input reception unit that receives an input of an intensity of one MS1 peak selected from one or a plurality of MS1 peaks appearing in an MS1 spectrum acquired by MS1 analysis, and an MS2 spectrum acquired by MS2 analysis using ions belonging to a mass-to-charge ratio range as precursor ions for a predetermined mass-to-charge ratio range including a mass-to-charge ratio corresponding to the selected one MS1 peak; a peak threshold setting unit that sets a peak threshold based on the intensity of the selected one MS1 peak; and a determination unit that compares the intensity of an MS2 peak appearing in the MS2 spectrum with the peak threshold, and determines that the MS2 spectrum is a chimeric MS2 spectrum when there is an MS2 peak having an intensity greater than the peak threshold.

A second aspect of a chromatograph mass spectrometry data processing apparatus according to the present invention for solving the above problem comprises: an input reception unit that receives an input of an intensity of one MS1 peak selected from one or a plurality of MS1 peaks appearing in an MS1 spectrum acquired by MS1 analysis, and an MS2 spectrum acquired by MS2 analysis using ions belonging to a mass-to-charge ratio range as precursor ions for a predetermined mass-to-charge ratio range including a mass-to-charge ratio corresponding to the selected one MS1 peak; a peak threshold setting unit that sets a peak threshold based on the intensity of the selected one MS1 peak; and a determination unit that compares a total value of intensities of a plurality of MS2 peaks appearing in the MS2 spectrum with the peak threshold, and determines that the MS2 spectrum is a chimeric MS2 spectrum when the total value is greater than the peak threshold.

### Advantageous Effects of Invention

In general, the intensity of a peak appearing in an MSn spectrum (n≥1) represents the detected amount of ions having the mass-to-charge ratio corresponding to the peak. Since each of the product ions obtained by dissociating one type of precursor ion was a component of the precursor ion before dissociation, it is considered that the detected amount of each of the product ions (the intensity of the MS2 peak) is less than or equal to the detected amount of the precursor ion (the intensity of the MS1 peak). Accordingly, in an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a predetermined mass-to-charge ratio range including the mass-to-charge ratio corresponding to the selected one MS1 peak as precursor ions (which may include ions corresponding to peaks other than the selected peak), it can be said that a product ion corresponding to an MS2 peak having an intensity greater than the intensity of the selected MS1 peak is not obtained by dissociating only the precursor ion corresponding to the selected MS1 peak. Therefore, by setting the intensity of the selected MS1 peak as the peak threshold, comparing the intensity of an MS2 peak appearing in the MS2 spectrum with the peak threshold, and if there is an MS2 peak with an intensity greater than the peak threshold, it can be determined that the MS2 spectrum is a chimeric MS2 spectrum. Further, in general, the intensity of a peak appearing in an MSn spectrum (n≥1) may include a certain degree of error. Therefore, by setting the peak threshold to a value obtained by multiplying the intensity of the selected MS1 peak by a predetermined factor according to the characteristics of the data, it is possible to more accurately determine whether the MS2 spectrum is a chimeric MS2 spectrum.

When the precursor ion is monovalent, the number of product ions obtained from one precursor ion is one. However, the type of product ion obtained differs depending on which atom constituting the precursor ion is charged. Even in that case, it is considered that the sum of the detected amounts of each of the product ions obtained by dissociating the precursor ion (the sum of the intensities of the MS2 peaks) is less than or equal to the detected amount of the precursor ion (the intensity of the MS1 peak). Accordingly, in an MS2 spectrum acquired by performing MS2 analysis using a monovalent ion belonging to a predetermined mass-to-charge ratio range as a precursor ion for a predetermined mass-to-charge ratio range including a mass-to-charge ratio corresponding to one MS1 peak selected from one or a plurality of MS1 peaks appearing in an MS1 spectrum acquired by MS1 analysis, if the sum of the intensities of a plurality of (or all) MS2 peaks appearing in the MS2 spectrum is greater than the intensity of the selected MS1 peak, it can be said that the MS2 spectrum was not obtained by dissociating only the precursor ion corresponding to the selected MS1 peak. Therefore, by setting the intensity of the selected MS1 peak as the peak threshold, comparing the sum of the intensities of a plurality of MS2 peaks appearing in the MS2 spectrum with the peak threshold, and if the sum is greater than the peak threshold, it can be determined that the MS2 spectrum is a chimeric MS2 spectrum. Further, in general, the intensity of a peak appearing in an MSn spectrum (n≥1) may include a certain degree of error. Therefore, by setting the peak threshold to a value obtained by multiplying the intensity of the selected MS1 peak by a predetermined factor according to the characteristics of the data, it is possible to more accurately determine whether the MS2 spectrum is a chimeric MS2 spectrum.

When the precursor ion is polyvalent, a plurality of product ions may be generated from one precursor ion because a plurality of atoms may be ionized by being charged. For example, when the precursor ion is divalent, the maximum number of product ions obtained from one precursor ion is two. In that case, by setting the peak threshold to a value obtained by multiplying the intensity value of the selected MS1 peak by the valence of the precursor ion corresponding to the selected MS1 peak, it is possible to more accurately determine whether the MS2 spectrum is a chimeric MS2 spectrum. Even if the peak threshold is set to the intensity value of the selected MS1 peak when the precursor ion is polyvalent, if the MS2 spectrum is a chimeric MS2 spectrum, the sum of the detected amounts of each of the product ions (the intensities of the MS2 peaks) obtained by dissociating the polyvalent precursor ion will still be greater than the detected amount of the precursor ion (the intensity of the selected MS1 peak), so a chimeric MS2 spectrum will not be erroneously determined not to be a chimeric MS2 spectrum.

As described above, with the chromatograph mass spectrometry data processing method and the chromatograph mass spectrometry data processing apparatus according to the present invention, it is possible to determine whether an MS2 spectrum acquired by DDA is a chimeric MS2 spectrum.

### BRIEF DESCRIPTION OF DRAWINGS

FIG. 1 is a schematic configuration diagram of an LC-MS analysis system.

FIG. 2 is a schematic diagram for explaining the flow of analysis by DDA.

FIG. 3 is a schematic diagram of an MS1 spectrum and an MS2 spectrum acquired by DDA at a certain retention time.

FIG. 4 is a schematic diagram of an MS1 spectrum and an MS2 spectrum acquired by DDA at a certain retention time.

FIG. 5 is a schematic diagram of an input screen for allowing a user to change the value of a peak threshold.

FIG. 6 is a schematic diagram of an MS1 spectrum and an MS2 spectrum acquired by DDA at a certain retention time.

FIG. 7 is a diagram showing a result of plotting pairs of the intensity of a selected MS1 peak and the total intensity of MS2 peaks appearing in an MS2 spectrum for a large number of MS2 spectra.

FIG. 8 is a schematic configuration diagram of a modified example of an analysis system that implements the chromatograph mass spectrometry data processing method according to the present invention.

### DESCRIPTION OF EMBODIMENTS

An LC-MS analysis system capable of implementing the chromatograph mass spectrometry data processing method according to the present invention will be described with reference to the accompanying drawings. It should be noted that the chromatograph mass spectrometry data processing method according to the present invention is embodied in a control/processing unit 4, which will be described later, and other configurations are not essential to the present invention and can be appropriately modified.

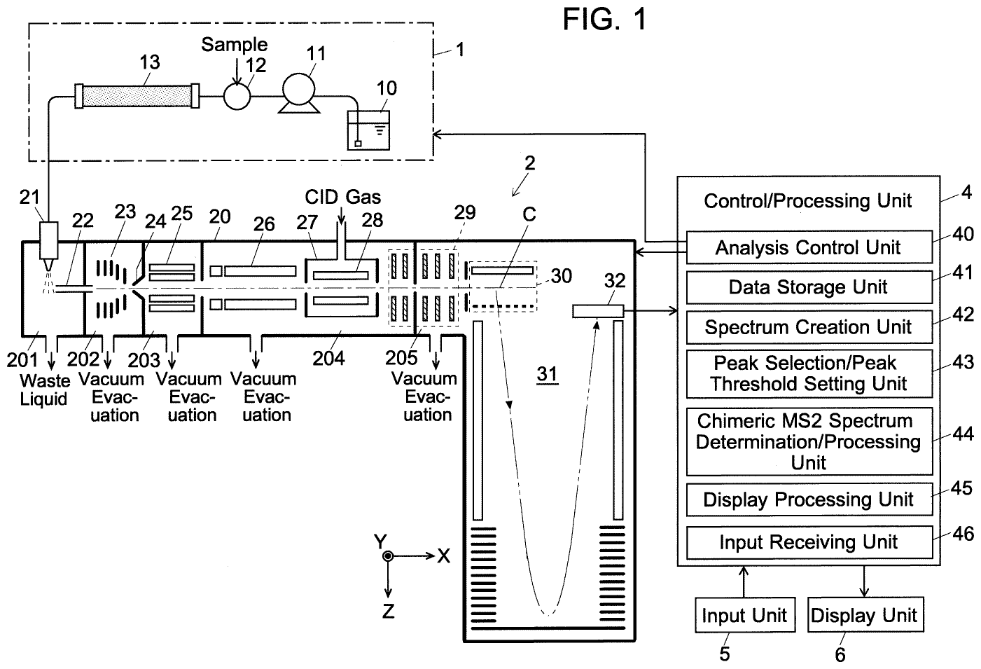

FIG. 1 is a schematic configuration diagram of the LC-MS analysis system. As shown in FIG. 1, this LC-MS analysis system includes a measurement unit including a liquid chromatograph unit 1 and a mass spectrometry unit 2, a control/processing unit 4, an input unit 5, and a display unit 6.

The liquid chromatograph unit 1 includes a mobile phase container 10 for storing a mobile phase, a liquid sending pump 11 for sucking the mobile phase and sending it in a substantially constant amount, an injector 12 for injecting a sample solution into the mobile phase, and a column 13 for separating a plurality of components contained in the sample solution for each retention time.

The mass spectrometry unit 2 is a quadrupole-time-of-flight (Q-TOF) type mass spectrometer, and includes an ionization chamber 201 in which the interior is at a substantially atmospheric pressure atmosphere, and a vacuum chamber 20 whose interior is partitioned into four sections. A first intermediate vacuum chamber 202, a second intermediate vacuum chamber 203, a first high vacuum chamber 204, and a second high vacuum chamber 205 are provided in the vacuum chamber 20, and each chamber is evacuated by a vacuum pump so that the degree of vacuum increases in this order. That is, the mass spectrometry unit 2 employs a multi-stage differential pumping system configuration.

In the ionization chamber 201, an electrospray ionization (ESI) probe 21 to which an eluate is supplied from the outlet of the column 13 is disposed, and the ionization chamber 201 and the first intermediate vacuum chamber 202 communicate with each other through a thin desolvation tube 22. The first intermediate vacuum chamber 202 and the second intermediate vacuum chamber 203 communicate with each other through an orifice formed at the top of a skimmer 24, and ion guides 23 and 25 are disposed in the first intermediate vacuum chamber 202 and the second intermediate vacuum chamber 203, respectively. In the first high vacuum chamber 204, a quadrupole mass filter 26 and a collision cell 27 in which an ion guide 28 is disposed are provided. Further, a plurality of electrodes disposed across the first high vacuum chamber 204 and the second high vacuum chamber 205 constitute an ion guide 29. Furthermore, in the second high vacuum chamber 205, an orthogonal acceleration type time-of-flight mass separator including an orthogonal accelerator 30 and an ion flight unit 31 having a reflectron, and an ion detector 32 are provided.

The control/processing unit 4 includes, as functional blocks, an analysis control unit 40, a data storage unit 41, a spectrum creation unit 42, a peak selection/peak threshold setting unit 43, a chimeric MS2 spectrum determination/processing unit 44, a display processing unit 45, and an input reception unit 46.

In general, the control/processing unit 4 is actually a personal computer, a workstation, or the like, and each of the functional blocks can be embodied by executing one or a plurality of dedicated software programs (computer programs) installed on such a computer. Such a computer program may be provided to a user by being stored in a computer-readable non-transitory recording medium such as a CD-ROM, a DVD-ROM, a memory card, or a USB memory (dongle). Alternatively, it may be provided to the user in the form of data transfer via a communication line such as the Internet. Alternatively, it may be pre-installed on a computer that is part of the system when the user purchases the system.

The analysis control unit 40 controls the measurement unit and executes an analysis on a prepared sample. In this LC-MS analysis system, in order to analyze a sample, such as a biological sample like blood, in which an enormous number of components are mixed and for which high-precision and comprehensive component identification is required, Data Dependent Acquisition (DDA), which is one of the analytical methods particularly effective for comprehensive component identification, is performed among MS2 analyses. Hereinafter, an outline of the LC/MS analysis operation of this LC-MS analysis system will be first described.

In the liquid chromatograph unit 1, the liquid sending pump 11 sucks the mobile phase from the mobile phase container 10 and sends it to the column 13 in a substantially constant amount. The injector 12 injects a sample into the mobile phase in accordance with an instruction from the analysis control unit 40. The sample is introduced into the column 13 on the mobile phase, and is separated for each retention time while passing through the column 13. The eluate eluting from the column 13 is introduced into the ESI probe 21, and the ESI probe 21 sprays the eluate as charged droplets into the ionization chamber 201. In the process where the charged droplets are atomized and the solvent in the droplets vaporizes, the sample components in the droplets become gas-phase ions.

The generated ions are sent into the first intermediate vacuum chamber 202 via the desolvation tube 22, and are introduced into the quadrupole mass filter 26 in the first high vacuum chamber 204 via the ion guide 23, the skimmer 24, and the ion guide 25 in this order. Predetermined voltages are applied to a plurality of rod electrodes constituting the quadrupole mass filter 26, and among the ions introduced into the quadrupole mass filter 26, ion species having a specific mass-to-charge ratio according to the voltage, or ion species included in a specific mass-to-charge ratio range according to the voltage are selected as precursor ions and pass through the quadrupole mass filter 26. A collision gas such as Ar gas is introduced into the collision cell 27, and the precursor ions come into contact with the collision gas and are dissociated by collision-induced dissociation (CID) to generate various product ions. The generated product ions are transported to the orthogonal accelerator 30 via the ion guide 29.

The mode of dissociation of the ions differs depending on the kinetic energy (collision energy) that the ions have when they enter the collision cell 27. Therefore, even if the precursor ions are the same, the types of product ions generated can be changed by appropriately adjusting the collision energy. It is also possible to leave some of the precursor ions without dissociating them, instead of dissociating all of them. As is well known, the collision energy is generally determined by the voltage difference between the DC bias voltage applied to the quadrupole mass filter 26 and the DC voltage applied to the lens electrode disposed at the ion inlet of the collision cell 27.

In the orthogonal accelerator 30, the ions are accelerated substantially simultaneously in a direction (Z-axis direction) substantially orthogonal to the incident direction (X-axis direction). The accelerated ions fly at a speed corresponding to their mass-to-charge ratio, fly back and forth in the ion flight unit 31 as shown by the two-dot chain line in FIG. 1, and reach the ion detector 32. Various ions that started from the orthogonal accelerator 30 at substantially the same time reach and are detected by the ion detector 32 in ascending order of mass-to-charge ratio, and the ion detector 32 outputs a detection signal (ion intensity signal) corresponding to the number of ions to the control/processing unit 4.

In the control/processing unit 4, the data storage unit 41 digitizes the detection signal, and further converts the flight time from the point when the ions are ejected from the orthogonal accelerator 30 into a mass-to-charge ratio to acquire and store MS1 spectrum data or MS2 spectrum data (in this specification, these may be collectively referred to as mass spectrum data). The orthogonal accelerator 30 repeatedly ejects ions toward the ion flight unit 31 at a predetermined cycle. As a result, the data storage unit 41 can repeatedly acquire mass spectrum data over a predetermined mass-to-charge ratio range at a predetermined cycle.

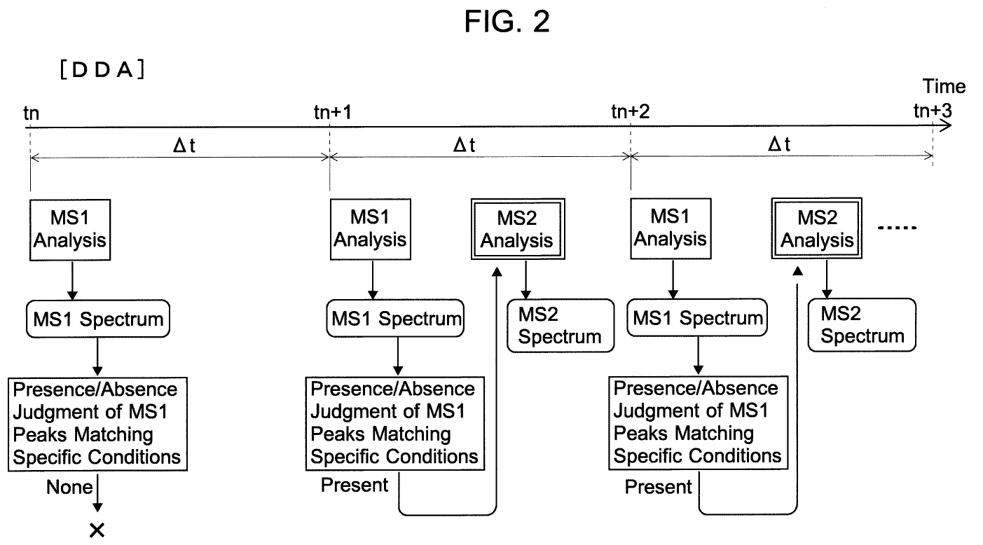

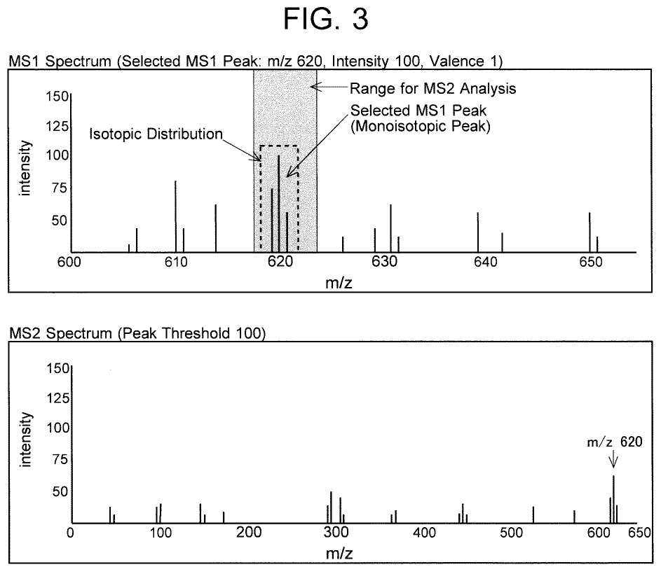

Next, the analysis operation by DDA of this LC-MS analysis system will be described with reference to FIGS. 2 and 3. FIG. 2 is a schematic diagram for explaining the flow of analysis by DDA. FIG. 3 is a schematic diagram of an MS1 spectrum and an MS2 spectrum acquired by DDA at a certain retention time. In DDA, MS1 analysis over a predetermined mass-to-charge ratio range is typically repeated at a constant cycle (at time Δt intervals in FIG. 2). In the control/processing unit 4, each time MS1 analysis is executed, the data storage unit 41 stores the MS1 spectrum data acquired in the MS1 analysis, the spectrum creation unit 42 reads the MS1 spectrum data from the data storage unit 41 to create an MS1 spectrum (upper diagram in FIG. 3), and the peak selection/peak threshold setting unit 43 checks whether an MS1 peak appearing in the MS1 spectrum meets a preset specific condition. Here, the “specific condition” can be, for example, that the peak intensity value is equal to or greater than a predetermined value. Then, if there is an MS1 peak that meets the specific condition, the peak selection/peak threshold setting unit 43 selects one MS1 peak from among the MS1 peaks that meet the specific condition (the MS1 peak selected in this way will be referred to as a selected MS1 peak), automatically determines the valence of the ion corresponding to the selected MS1 peak by a known method, and sets a peak threshold based on the intensity value of the selected MS1 peak (details of the peak threshold will be described later). At the same time, the analysis control unit 40 executes an MS2 analysis using ions belonging to a predetermined (several Da width) mass-to-charge ratio range (shaded area in the upper diagram of FIG. 3) including the mass-to-charge ratio corresponding to the selected MS1 peak as precursor ions, subsequent to the MS1 analysis. When the MS2 analysis is executed, the data storage unit 41 stores the acquired MS2 spectrum data, the mass-to-charge ratio value corresponding to the selected MS1 peak, the valence of the ion corresponding to the selected MS1 peak, and the peak threshold in association with the MS1 spectrum data, and the spectrum creation unit 42 reads the MS2 spectrum data from the data storage unit 41 to create an MS2 spectrum. The MS1 spectrum and the MS2 spectrum created by the spectrum creation unit 42 may be stored in the data storage unit 41 in association with the MS1 spectrum data and the MS2 spectrum data, respectively.

In the example shown in FIG. 2, only one MS2 analysis is performed following the MS1 analysis, but if time permits, a plurality of MS2 analyses for different precursor ions can be performed following one MS1 analysis. In that case, for example, a predetermined number of MS1 peaks can be selected in descending order of intensity from among the MS1 peaks appearing in the MS1 spectrum, and for each of the selected MS1 peaks, an MS2 analysis can be performed in sequence using ions belonging to a predetermined mass-to-charge ratio range including the corresponding mass-to-charge ratio as precursor ions. As can be seen from FIG. 2, in DDA, an MS2 spectrum corresponding to an MS1 spectrum obtained at a certain retention time does not necessarily exist.

When a selected MS1 peak is selected from a plurality of MS1 peaks constituting an isotope distribution, the monoisotopic peak of the isotope distribution (a peak derived from a molecule consisting of the most abundant isotopes of each element constituting the sample molecule) is usually selected as the selected MS1 peak. In the isotope distribution, which peak is the monoisotopic peak is automatically determined during analysis by DDA. In this embodiment as well, when a selected MS1 peak is selected from a plurality of MS1 peaks constituting an isotope distribution, an m/z value range including the monoisotopic peak of the isotope distribution can be selected.

When an LC/MS analysis using DDA as described above is performed on one sample, the data storage unit 41 stores the MS1 spectrum data and the MS2 spectrum data corresponding to the LC/MS analysis. Further, for each selected MS1 peak, its corresponding mass-to-charge ratio value, the valence of the ion, and the peak threshold are stored in association with each other. Under the condition that such data is stored, the control/processing unit 4 executes the following data processing. Hereinafter, some examples of the data processing will be described.

### <First Data Processing Method>

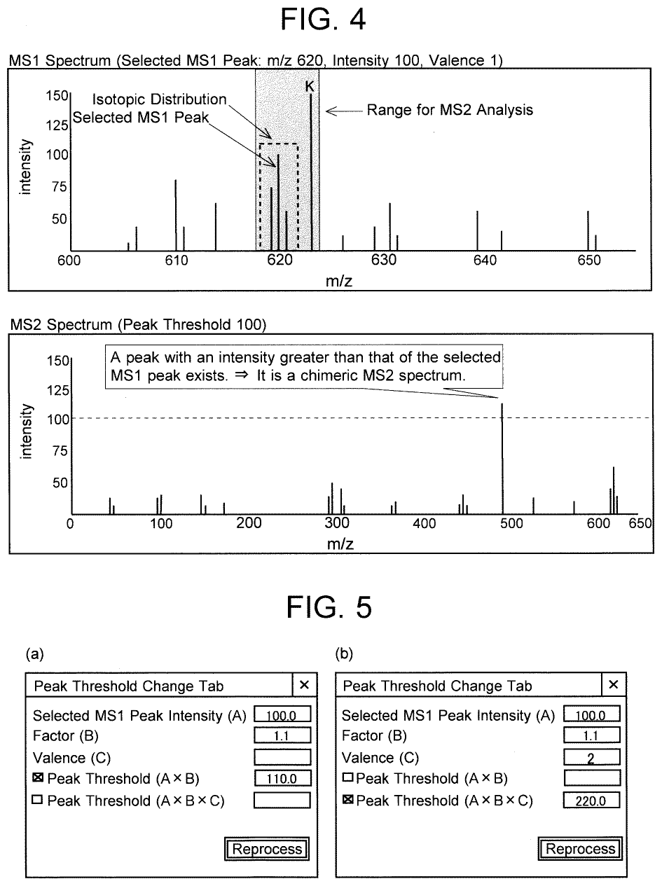

The first data processing method will be described with reference to FIG. 4. FIG. 4 is a schematic diagram of an MS1 spectrum and an MS2 spectrum acquired by DDA at a certain retention time. As shown in FIG. 4, the header portion of the MS1 spectrum can display the mass-to-charge ratio value corresponding to the selected MS1 peak, the intensity of the selected MS1 peak, and the valence of the ion corresponding to the selected MS1 peak, and the header portion of the MS2 spectrum can display the peak threshold. In the first data processing method, the chimeric MS2 spectrum determination/processing unit 44 reads an MS2 spectrum and a peak threshold stored in association with the MS2 spectrum from the data storage unit 41, and compares the intensity of an MS2 peak appearing in the MS2 spectrum with the peak threshold. Then, as shown in the lower diagram of FIG. 4, when there is an MS2 peak having an intensity greater than the peak threshold, it is determined that the MS2 spectrum is a chimeric MS2 spectrum.

As the peak threshold, as shown in FIG. 4, the intensity of the selected MS1 peak can be used. In general, the intensity of a peak appearing in an MSn spectrum (n≥1) represents the detected amount of ions having the mass-to-charge ratio corresponding to the peak. Since each of the product ions obtained by dissociating one type of precursor ion was a component of the precursor ion before dissociation, it is considered that the detected amount of each of the product ions (the intensity of the MS2 peak) is less than or equal to the detected amount of the precursor ion (the intensity of the MS1 peak). Accordingly, in an MS2 spectrum acquired by MS2 analysis using ions belonging to a predetermined mass-to-charge ratio range including the mass-to-charge ratio corresponding to the selected MS1 peak as precursor ions (which may include ions corresponding to peaks other than the selected peak), it can be said that a product ion corresponding to an MS2 peak having an intensity greater than the intensity of the selected MS1 peak is not obtained by dissociating only the precursor ion corresponding to the selected MS1 peak. For example, to explain with the upper diagram of FIG. 4, it can be said that it is a product ion obtained by dissociating the ion corresponding to peak K (however, the actual MS1 spectrum is more complex than that shown in the upper diagram of FIG. 4, and it is not necessarily clear which peak's corresponding ion was dissociated to obtain the product ion). Therefore, by setting the intensity of the selected MS1 peak as the peak threshold, comparing the intensity of an MS2 peak appearing in the MS2 spectrum with the peak threshold, and if there is an MS2 peak with an intensity greater than the peak threshold, it can be determined that the MS2 spectrum is a chimeric MS2 spectrum.

Alternatively, the peak threshold can be a value obtained by multiplying the intensity of the selected MS1 peak by 0.8 to 1.2. In general, the intensity value of a mass spectrum can include an error of about 20%. Therefore, it is preferable to set a more appropriate threshold by multiplying the intensity of the selected MS1 peak by a value in the range of 0.8 to 1.2 as the peak threshold according to the characteristics of the data. What multiple of the intensity of the selected MS1 peak is appropriate for the peak threshold is found empirically according to the measurement conditions of the data. Therefore, it is preferable to set an appropriate multiplication factor using one or a plurality of data that are known to be chimeric MS2 spectra and were acquired under the same measurement conditions as the data to be processed. By setting the peak threshold to a value obtained by multiplying the intensity of the selected MS1 peak by a predetermined factor according to the characteristics of the data, it is possible to more accurately determine whether the MS2 spectrum is a chimeric MS2 spectrum.

The chimeric MS2 spectrum determination/processing unit 44 may determine whether the MS2 spectrum is a chimeric MS2 spectrum after comparing the intensities of all MS2 peaks appearing in the MS2 spectrum to be processed with the peak threshold. Alternatively, the intensities of all MS2 peaks appearing in the MS2 spectrum to be processed may be compared with the peak threshold in a predetermined order (for example, the order stored in a data file), and when it is found that there is an MS2 peak having an intensity greater than the peak threshold, it may be determined that the MS2 spectrum is a chimeric MS2 spectrum. In this case, the process of comparing the intensity of the MS2 peak with the peak threshold may be terminated after the determination, or may be continued.

The operation of the chimeric MS2 spectrum determination/processing unit 44 may be performed automatically at the same time as the data required for determination is stored in the data storage unit 41, may be performed automatically after the operation of the measurement unit, that is, the analysis by DDA, is completed, or may be performed after the input reception unit 46 receives an input from the user via the input unit 5 instructing to start the determination and processing.

The chimeric MS2 spectrum determination/processing unit 44 can process the MS2 spectrum determined to be a chimeric MS2 spectrum and/or the corresponding MS2 spectrum data in various ways. For example, the MS2 spectrum data determined to be a chimeric MS2 spectrum may be stored in the data storage unit 41 separately from the MS2 spectrum data not determined to be a chimeric MS2 spectrum. Alternatively, a label may be attached to the MS2 spectrum data determined to be a chimeric MS2 spectrum. Alternatively, a label may be attached to the data corresponding to the MS2 peak having an intensity greater than the peak threshold in the MS2 spectrum data, or the data may be deleted.

The display processing unit 45 reads the MS1 spectrum and/or the MS2 spectrum from the data storage unit 41 and displays it on the display unit 6. At this time, if the chimeric MS2 spectrum determination/processing unit 44 stores the MS2 spectrum data determined to be a chimeric MS2 spectrum separately from the MS2 spectrum data not determined to be a chimeric MS2 spectrum in the data storage unit 41, or if it attaches a label to the MS2 spectrum data determined to be a chimeric MS2 spectrum, the display processing unit 45 can be configured not to read the MS2 spectrum data determined to be a chimeric MS2 spectrum from the data storage unit 41, or even if it is read, not to display it on the display unit 6. By doing so, the user is saved the waste of trying to identify components from a chimeric MS2 spectrum. Further, if the chimeric MS2 spectrum determination/processing unit 44 has attached a label to the data corresponding to the MS2 peak having an intensity greater than the peak threshold, or has deleted the data, the display processing unit 45 can display the MS2 spectrum after not displaying the MS2 peak having an intensity greater than the peak threshold (that is, the MS2 peak corresponding to an ion derived from a component different from the component from which the ion corresponding to the selected MS1 peak is derived), or after performing a process of setting the intensity to 0. By doing so, in the chimeric MS2 spectrum, the contribution of a component different from the component from which the ion corresponding to the selected MS1 peak is derived can be reduced, and the purity of the MS2 spectrum can be increased. As a result, component identification in the chimeric MS2 spectrum becomes easier.

The display processing unit 45 may perform the above-described processing automatically, or may perform it after the input reception unit 46 receives an input from the user via the input unit 5 instructing to start the display processing.

The display processing unit 45 can display an input screen as shown in FIG. 5(a) for allowing the user to change the value of the peak threshold. The input reception unit 46 receives various inputs made by the user through the input unit 5 and outputs the content of the inputs to each unit. For example, on an input screen for allowing the user to change the value of the peak threshold as shown in FIG. 5(a), when the user sets the mode to one where the peak threshold is a value obtained by multiplying the selected MS1 peak by a predetermined factor (the x mark in the figure represents mode selection) and changes the value in either the “Factor” field or the “Peak Threshold” field, the input reception unit 46 updates the other value and displays the various parameters after the change. Subsequently, when the user presses the “Reprocess” button, the input reception unit 46 can output the changed peak threshold to the chimeric MS2 spectrum determination/processing unit 44 and output a signal instructing the chimeric MS2 spectrum determination/processing unit 44 to perform the determination and processing again. Upon receiving this signal, the chimeric MS2 spectrum determination/processing unit 44 can perform the determination and processing as described above again. Being able to perform such an operation allows for determination and processing that utilize the user's knowledge, and it is possible to more accurately determine whether it is a chimeric MS2 spectrum. Further, since fine adjustment of the peak threshold can be easily repeated, it is convenient for the user who ultimately performs component identification.

The initial value of the peak threshold may be automatically set to the intensity of the selected MS1 peak, or may be preset by the user in the manner described above.

### <Second Data Processing Method>

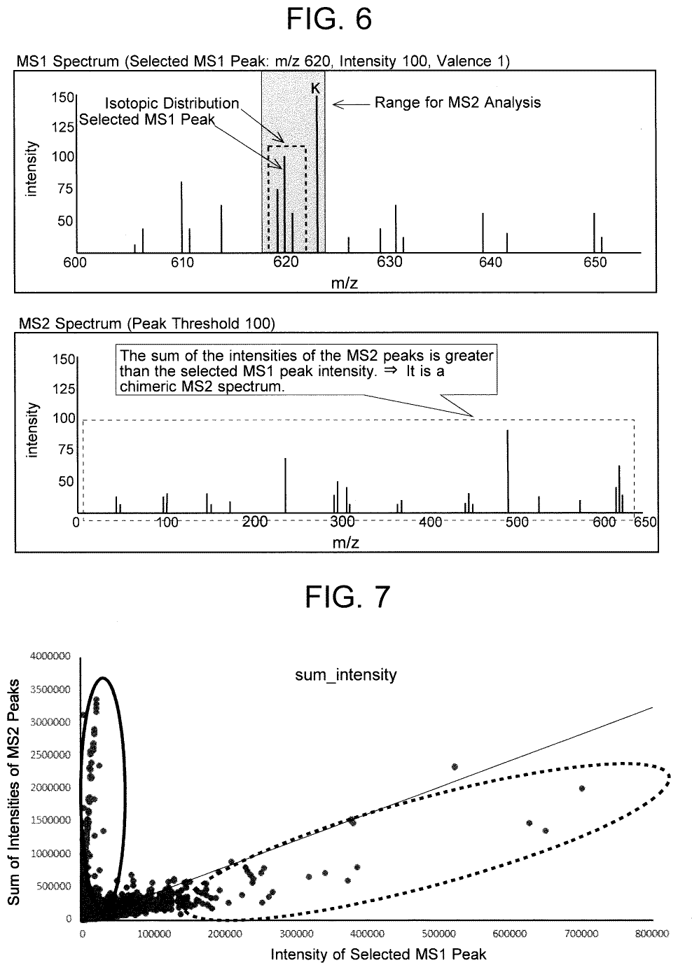

The second data processing method will be described with reference to FIG. 6. FIG. 6 is a schematic diagram of an MS1 spectrum and an MS2 spectrum acquired by DDA at a certain retention time. As shown in FIG. 6, the header portion of the MS1 spectrum can display the mass-to-charge ratio value corresponding to the selected MS1 peak, the intensity of the selected MS1 peak, and the valence of the ion corresponding to the selected MS1 peak, and the header portion of the MS2 spectrum can display the peak threshold. In the second data processing method, the chimeric MS2 spectrum determination/processing unit 44 reads an MS2 spectrum and a peak threshold stored in association with the MS2 spectrum from the data storage unit 41, calculates the sum of the intensities of a plurality of (in FIG. 6, all) MS2 peaks appearing in the MS2 spectrum, and compares the sum with the peak threshold. Then, as shown in the lower diagram of FIG. 6, when the sum is greater than the peak threshold, it is determined that the MS2 spectrum is a chimeric MS2 spectrum.

As the peak threshold, as shown in FIG. 6, the intensity of the selected MS1 peak can be used. Usually, the precursor ion is monovalent, and in that case, the number of product ions obtained from one precursor ion is one. However, the type of product ion obtained differs depending on which atom constituting the precursor ion is charged. Even in that case, it is considered that the sum of the detected amounts of each of the product ions obtained by dissociating the precursor ion (the sum of the intensities of the MS2 peaks) is less than or equal to the detected amount of the precursor ion (the intensity of the MS1 peak). Accordingly, in an MS2 spectrum acquired by MS2 analysis using a monovalent ion belonging to a predetermined mass-to-charge ratio range as a precursor ion for a predetermined mass-to-charge ratio range including the mass-to-charge ratio corresponding to the selected MS1 peak, if the sum of the intensities of a plurality of (or all) MS2 peaks appearing in the MS2 spectrum is greater than the intensity of the selected MS1 peak, it can be said that the MS2 spectrum was not obtained by dissociating only the precursor ion corresponding to the selected MS1 peak. For example, to explain with the upper diagram of FIG. 6, it can be said that it is a product ion obtained by dissociating the ion corresponding to peak K (however, the actual MS1 spectrum is more complex than that shown in the upper diagram of FIG. 6, and it is not necessarily clear which peak's corresponding ion was dissociated to obtain the product ion). Therefore, by setting the intensity of the selected MS1 peak as the peak threshold, calculating the sum of the intensities of a plurality of MS2 peaks appearing in the MS2 spectrum, comparing the sum with the peak threshold, and if the sum is greater than the peak threshold, it can be determined that the MS2 spectrum is a chimeric MS2 spectrum.

Alternatively, as described in the first processing method, the peak threshold can be a value obtained by multiplying the intensity of the selected MS1 peak by a predetermined factor (preferably 0.8 to 1.2).

When the precursor ion is polyvalent, a plurality of product ions may be generated from one precursor ion because a plurality of atoms may be ionized by being charged. For example, when the precursor ion is divalent, the maximum number of product ions obtained from one precursor ion is two. In that case, by setting the peak threshold to a value obtained by multiplying the intensity value of the selected MS1 peak by the valence of the precursor ion corresponding to the selected MS1 peak, it is possible to more accurately determine whether the MS2 spectrum is a chimeric MS2 spectrum. The valence of the precursor ion depends to some extent on the type of sample and the type of ionization method for the sample, so it can be predicted to some extent empirically. For example, when a peptide is ionized and measured by ESI, divalent to tetravalent precursor ions are often generated, and pentavalent or higher precursor ions are rarely generated. Further, in the case of Matrix Assisted Laser Desorption/Ionization (MALDI), monovalent ions are generated with high probability regardless of the sample being measured. Therefore, when setting the peak threshold to a value obtained by multiplying the intensity value of the selected MS1 peak by the valence of the precursor ion corresponding to the selected MS1 peak, by predicting and determining the valence of the precursor ion based on the type of sample and the type of ionization method for the sample, the peak threshold can be set with higher accuracy even if the valence of the precursor ion is not clear.

As an example, FIG. 7 shows a result of plotting pairs of the intensity of a selected MS1 peak and the sum of the intensities of MS2 peaks appearing in an MS2 spectrum for a large number of MS2 spectra, in a case where a peptide was ionized and measured by ESI. In this example, the valence of the ion corresponding to the selected MS1 peak is in all cases from 2 to 4. In the plots enclosed by the solid line, the sum of the intensities of the MS2 peaks appearing in the MS2 spectrum is much larger than 4 times the intensity of the corresponding selected MS1 peak (for reference, a straight line passing through the origin with a slope of 4 is shown in the figure), and it is considered that the MS2 spectra corresponding to these plots are chimeric MS2 spectra. When confirmed by other known methods, most of them were chimeric MS2 spectra. In the plots enclosed by the broken line, the sum of the intensities of the MS2 peaks appearing in the MS2 spectrum is generally 4 times or less the intensity of the corresponding selected MS1 peak, and it is considered that the MS2 spectra corresponding to these plots are not chimeric MS2 spectra. When confirmed by other known methods, most of them were not chimeric MS2 spectra.

The chimeric MS2 spectrum determination/processing unit 44 may compare the sum of the intensities of all MS2 peaks appearing in the MS2 spectrum to be processed with the peak threshold. Alternatively, it may compare the sum of the intensities of a predetermined number of MS2 peaks among all MS2 peaks appearing in the MS2 spectrum to be processed with the peak threshold. In this case, the predetermined number of MS2 peaks may be selected in descending order of their intensity, may be selected in the order they are stored in a data file, or a plurality of combinations may be prepared (in this case, the comparison between the sum of the intensities of the MS2 peaks and the peak threshold can be performed multiple times).

Even if the peak threshold is set to the intensity value of the selected MS1 peak when the precursor ion is polyvalent, if the MS2 spectrum is a chimeric MS2 spectrum, the sum of the detected amounts of each of the product ions (the intensities of the MS2 peaks) obtained by dissociating the polyvalent precursor ion will still be greater than the detected amount of the precursor ion (the intensity of the selected MS1 peak), so it can be determined that the MS2 spectrum is a chimeric MS2 spectrum.

The operation of the chimeric MS2 spectrum determination/processing unit 44 may be performed automatically at the same time as the data required for determination is stored in the data storage unit 41, as described in the first processing method, may be performed automatically after the operation of the measurement unit, that is, the analysis by DDA, is completed, or may be performed after the input reception unit 46 receives an input from the user via the input unit 5 instructing to start the determination and processing.

The chimeric MS2 spectrum determination/processing unit 44 can process the MS2 spectrum determined to be a chimeric MS2 spectrum and/or the corresponding MS2 spectrum data in various ways. The details are the same as in the first processing method, so a description thereof is omitted.

The display processing unit 45 reads the MS1 spectrum and/or the MS2 spectrum from the data storage unit 41 and displays it on the display unit 6. The details are the same as in the first processing method, so a description thereof is omitted.

The display processing unit 45 may perform the above-described processing automatically, as described in the first processing method, or may perform it after the input reception unit 46 receives an input from the user via the input unit 5 instructing to start the display processing.

The display processing unit 45 can display an input screen as shown in FIG. 5(b) for allowing the user to change the value of the peak threshold. The input reception unit 46, similarly to the first analysis method, receives various inputs made by the user through the input unit 5 and outputs the content of the inputs to each unit. For example, on an input screen for allowing the user to change the value of the peak threshold as shown in FIG. 5(b), when the user sets the mode to one where the peak threshold is a value obtained by multiplying the intensity of the selected MS1 peak by a predetermined factor and the valence of the ion corresponding to the selected MS1 peak (the x mark in the figure represents mode selection) and changes the value in either the “Factor” field or the “Peak Threshold” field, the input reception unit 46 can update the other value and display the peak threshold after the change. The processing after the user presses the “Reprocess” button is the same as in the first processing method, so a description thereof is omitted.

As in the first processing method, the initial value of the peak threshold may be automatically set to the intensity of the selected MS1 peak, or may be preset by the user in the manner described above.

### [Modified Example]

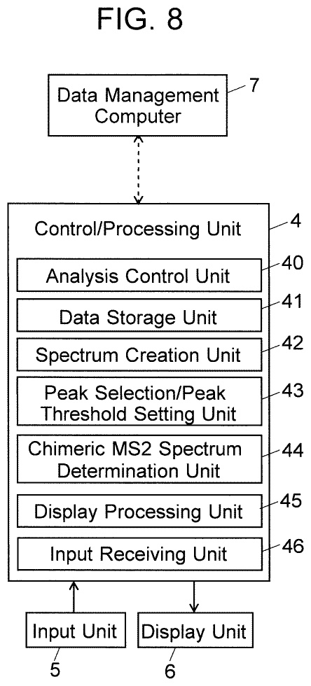

As described above, the chromatograph mass spectrometry data processing method according to the present invention is embodied in the control/processing unit 4, and other configurations are not essential to the present invention and can be appropriately modified. That is, for the chromatograph mass spectrometry data processing method according to the present invention, the measurement unit is not essential, and a data management computer 7 as shown in FIG. 8, for example, may be provided instead of the measurement unit. The data management computer stores analysis results by DDA performed in the past, in particular, MS1 spectrum data and MS2 spectrum data, and further, the mass-to-charge ratio value corresponding to each selected MS1 peak, the valence of the ion corresponding to the selected MS1 peak, and the peak threshold are stored in association with each other. By the data storage unit 41 reading and storing these data from the data management computer 7, for example, the first processing method and the second processing method described above can be implemented.

Both the first data processing method and the second data processing method may be executed on the same MS2 spectrum data. This allows for a more reliable determination of a chimeric MS2 spectrum.

### [Aspects]

It will be apparent to those skilled in the art that the exemplary embodiments described above are specific examples of the following aspects.

(Item 1) A chromatograph mass spectrometry data processing method according to one aspect of the present invention is a chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a mass-to-charge ratio range as precursor ions for a predetermined mass-to-charge ratio range including the mass-to-charge ratio corresponding to the selected one MS1 peak, the method comprising:
a process of setting a peak threshold based on the intensity of the selected one MS1 peak; and
a process of comparing the intensity of an MS2 peak appearing in the MS2 spectrum with the peak threshold, and determining that the MS2 spectrum is a chimeric MS2 spectrum when there is an MS2 peak having an intensity greater than the peak threshold.

(Item 10) A chromatograph mass spectrometry data processing apparatus according to one aspect of the present invention comprises:
an input reception unit that receives an input of an intensity of one MS1 peak selected from one or a plurality of MS1 peaks appearing in an MS1 spectrum acquired by MS1 analysis, and an MS2 spectrum acquired by MS2 analysis using ions belonging to a mass-to-charge ratio range as precursor ions for a predetermined mass-to-charge ratio range including a mass-to-charge ratio corresponding to the selected one MS1 peak;
a peak threshold setting unit that sets a peak threshold based on the intensity of the selected one MS1 peak; and
a determination unit that compares the intensity of an MS2 peak appearing in the MS2 spectrum with the peak threshold, and determines that the MS2 spectrum is a chimeric MS2 spectrum when there is an MS2 peak having an intensity greater than the peak threshold.

In general, the intensity of a peak appearing in an MSn spectrum (n≥1) represents the detected amount of ions having the mass-to-charge ratio corresponding to the peak. Since each of the product ions obtained by dissociating one type of precursor ion was a component of the precursor ion before dissociation, it is considered that the detected amount of each of the product ions (the intensity of the MS2 peak) is less than or equal to the detected amount of the precursor ion (the intensity of the MS1 peak). Accordingly, in an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a predetermined mass-to-charge ratio range including the mass-to-charge ratio corresponding to the selected one MS1 peak as precursor ions (which may include ions corresponding to peaks other than the selected peak), it can be said that a product ion corresponding to an MS2 peak having an intensity greater than the intensity of the selected MS1 peak is not obtained by dissociating only the precursor ion corresponding to the selected MS1 peak. Therefore, according to the chromatograph mass spectrometry data processing method of Item 1 and the chromatograph mass spectrometry data processing apparatus of Item 10, by setting the intensity of the selected MS1 peak as the peak threshold, comparing the intensity of an MS2 peak appearing in the MS2 spectrum with the peak threshold, and if there is an MS2 peak with an intensity greater than the peak threshold, it can be determined that the MS2 spectrum is a chimeric MS2 spectrum.

(Item 2) The chromatograph mass spectrometry data processing method according to Item 2 is the chromatograph mass spectrometry data processing method according to Item 1, further comprising a process of treating the intensity of an MS2 peak having an intensity greater than the peak threshold as 0.

According to the mass spectrometry data processing method of Item 2, in a chimeric MS2 spectrum, the contribution of a component different from the component from which the ion corresponding to the selected MS1 peak is derived can be reduced, and the purity of the MS2 spectrum can be increased. As a result, component identification in the chimeric MS2 spectrum becomes easier.

(Item 4) A chromatograph mass spectrometry data processing method according to one aspect of the present invention is a chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a mass-to-charge ratio range as precursor ions for a predetermined mass-to-charge ratio range including the mass-to-charge ratio corresponding to the selected one MS1 peak, the method comprising: a process of setting a peak threshold based on the intensity of the selected one MS1 peak; and a process of comparing a total value of intensities of a plurality of MS2 peaks appearing in the MS2 spectrum with the peak threshold, and determining that the MS2 spectrum is a chimeric MS2 spectrum when the total value is greater than the peak threshold.

(Item 11) A chromatograph mass spectrometry data processing apparatus according to one aspect of the present invention comprises: an input reception unit that receives an input of an intensity of one MS1 peak selected from one or a plurality of MS1 peaks appearing in an MS1 spectrum acquired by MS1 analysis, and an MS2 spectrum acquired by MS2 analysis using ions belonging to a mass-to-charge ratio range as precursor ions for a predetermined mass-to-charge ratio range including a mass-to-charge ratio corresponding to the selected one MS1 peak; a peak threshold setting unit that sets a peak threshold based on the intensity of the selected one MS1 peak; and a determination unit that compares a total value of intensities of a plurality of MS2 peaks appearing in the MS2 spectrum with the peak threshold, and determines that the MS2 spectrum is a chimeric MS2 spectrum when the total value is greater than the peak threshold.

When the precursor ion is monovalent, the number of product ions obtained from one precursor ion is one. However, the type of product ion obtained differs depending on which atom constituting the precursor ion is charged. Even in that case, it is considered that the sum of the detected amounts of each of the product ions obtained by dissociating the precursor ion (the sum of the intensities of the MS2 peaks) is less than or equal to the detected amount of the precursor ion (the intensity of the MS1 peak). Accordingly, in an MS2 spectrum acquired by performing MS2 analysis using a monovalent ion belonging to a predetermined mass-to-charge ratio range as a precursor ion for a predetermined mass-to-charge ratio range including a mass-to-charge ratio corresponding to one MS1 peak selected from one or a plurality of MS1 peaks appearing in an MS1 spectrum acquired by MS1 analysis, if the sum of the intensities of a plurality of (or all) MS2 peaks appearing in the MS2 spectrum is greater than the intensity of the selected MS1 peak, it can be said that the MS2 spectrum was not obtained by dissociating only the precursor ion corresponding to the selected MS1 peak. Therefore, according to the chromatograph mass spectrometry data processing method of Item 4 and the chromatograph mass spectrometry data processing apparatus of Item 11, by setting the intensity of the selected MS1 peak as the peak threshold, comparing the sum of the intensities of a plurality of MS2 peaks appearing in the MS2 spectrum with the peak threshold, and if the sum is greater than the peak threshold, it can be determined that the MS2 spectrum is a chimeric MS2 spectrum.

(Item 3) The chromatograph mass spectrometry data processing method according to Item 3 is the chromatograph mass spectrometry data processing method according to Item 1 or 2, further comprising a process of comparing a total value of intensities of a plurality of MS2 peaks appearing in the MS2 spectrum with the peak threshold, and determining that the MS2 spectrum is a chimeric MS2 spectrum when the total value is greater than the peak threshold.

According to the chromatograph mass spectrometry data processing method of Item 3, by executing both the determination in the method of Item 1 and the determination in the method of Item 4, the determination of a chimeric MS2 spectrum can be performed more reliably.

(Item 5) The chromatograph mass spectrometry data processing method according to Item 5 is the chromatograph mass spectrometry data processing method according to any one of Items 1 to 4, wherein the peak threshold is the intensity of the selected MS1 peak.

(Item 6) The chromatograph mass spectrometry data processing method according to Item 6 is the chromatograph mass spectrometry data processing method according to any one of Items 1 to 4, wherein the peak threshold is a value obtained by multiplying the intensity of the selected MS1 peak by a predetermined factor.

(Item 7) The chromatograph mass spectrometry data processing method according to Item 7 is the chromatograph mass spectrometry data processing method according to Item 6, wherein the predetermined factor is in the range of 0.8 to 1.2.

In general, the intensity of a peak appearing in an MSn spectrum (n≥1) may include a certain degree of error (typically, about 20%). According to the chromatograph mass spectrometry data processing methods of Items 5 to 7, by setting the peak threshold to a value obtained by multiplying the intensity of the selected MS1 peak by a predetermined factor, particularly 0.8 to 1.2, according to the characteristics of the data, it is possible to more accurately determine whether the MS2 spectrum is a chimeric MS2 spectrum.

(Item 8) The chromatograph mass spectrometry data processing method according to Item 8 is the chromatograph mass spectrometry data processing method according to Item 3 or 4, wherein the peak threshold is a value obtained by multiplying the intensity of the selected MS1 peak by the valence of the ion corresponding to the selected MS1 peak.

When the precursor ion is polyvalent, a plurality of product ions may be generated from one precursor ion because a plurality of atoms may be ionized by being charged. For example, when the precursor ion is divalent, the maximum number of product ions obtained from one precursor ion is two. In that case, by setting the peak threshold to a value obtained by multiplying the intensity value of the selected MS1 peak by the valence of the precursor ion corresponding to the selected MS1 peak, the determination by comparison between the sum of the intensities of the MS2 peaks and the peak threshold performed in the chromatograph mass spectrometry data processing method according to Item 3 or 4 can be performed more accurately. That is, according to the chromatograph mass spectrometry data processing method of Item 8, the determination by comparison between the sum of the intensities of the MS2 peaks and the peak threshold performed in the chromatograph mass spectrometry data processing method according to Item 3 or 4 can be performed more accurately. Even if the peak threshold is set to the intensity value of the selected MS1 peak when the precursor ion is polyvalent, if the MS2 spectrum is a chimeric MS2 spectrum, the sum of the detected amounts of each of the product ions (the intensities of the MS2 peaks) obtained by dissociating the polyvalent precursor ion will still be greater than the detected amount of the precursor ion (the intensity of the selected MS1 peak), so a chimeric MS2 spectrum will not be erroneously determined not to be a chimeric MS2 spectrum.

(Item 9) The chromatograph mass spectrometry data processing method according to Item 9 is the chromatograph mass spectrometry data processing method according to Item 8, wherein a value predicted based on the type of sample and the type of ionization method for the sample is used as the valence of the ion corresponding to the selected MS1 peak.

The valence of the precursor ion depends to some extent on the type of sample and the type of ionization method for the sample, so it can be predicted to some extent empirically. Therefore, according to the chromatograph mass spectrometry data processing method of Item 9, by predicting and determining the valence of the precursor ion based on the type of sample and the type of ionization method for the sample, the peak threshold can be set with higher accuracy even if the valence of the precursor ion is not clear.

### REFERENCE SIGNS LIST

1 . . . Liquid chromatograph unit
10 . . . Mobile phase container
11 . . . Liquid sending pump
12 . . . Injector
13 . . . Column
2 . . . Mass spectrometry unit
20 . . . Vacuum chamber
201 . . . Ionization chamber
202 . . . First intermediate vacuum chamber
203 . . . Second intermediate vacuum chamber
204 . . . First high vacuum chamber
205 . . . Second high vacuum chamber
21 . . . ESI probe
22 . . . Desolvation tube
23, 25, 28, 29 . . . Ion guide
24 . . . Skimmer
26 . . . Quadrupole mass filter
27 . . . Collision cell
30 . . . Orthogonal accelerator
31 . . . Ion flight unit
32 . . . Ion detector
4 . . . Control/processing unit
40 . . . Analysis control unit
41 . . . Data storage unit
42 . . . Spectrum creation unit
43 . . . Peak selection/peak threshold setting unit
44 . . . Chimeric MS2 spectrum determination/processing unit
45 . . . Display processing unit
46 . . . Input reception unit
5 . . . Input unit
6 . . . Display unit
7 . . . Data management computer

What is claimed is:

1. A chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a mass-to-charge ratio range as precursor ions for a predetermined mass-to-charge ratio range including a mass-to-charge ratio corresponding to the selected one MS1 peak, the method comprising:
a step of setting a peak threshold based on an intensity of the selected one MS1 peak; and
a step of comparing an intensity of an MS2 peak appearing in the MS2 spectrum with the peak threshold, and determining that the MS2 spectrum is a chimeric MS2 spectrum when there is an MS2 peak having an intensity greater than the peak threshold.

2. The chromatograph mass spectrometry data processing method according to claim 1, further comprising:
a step of changing an intensity of an MS2 peak having an intensity greater than the peak threshold to 0.

3. The chromatograph mass spectrometry data processing method according to claim 1, further comprising:
a step of comparing a total value of intensities of a plurality of MS2 peaks appearing in the MS2 spectrum with the peak threshold, and determining that the MS2 spectrum is a chimeric MS2 spectrum when the total value is greater than the peak threshold.

4. A chromatograph mass spectrometry data processing method for processing an MS2 spectrum acquired by performing MS1 analysis to acquire an MS1 spectrum, selecting one MS1 peak from one or a plurality of MS1 peaks appearing in the acquired MS1 spectrum, and performing MS2 analysis using ions belonging to a mass-to-charge ratio range as precursor ions for a predetermined mass-to-charge ratio range including a mass-to-charge ratio corresponding to the selected one MS1 peak, the method comprising:
a step of setting a peak threshold based on an intensity of the selected one MS1 peak; and
a step of comparing a total value of intensities of a plurality of MS2 peaks appearing in the MS2 spectrum with the peak threshold, and determining that the MS2 spectrum is a chimeric MS2 spectrum when the total value is greater than the peak threshold.

5. The chromatograph mass spectrometry data processing method according to claim 1, wherein the peak threshold is the intensity of the selected MS1 peak.

6. The chromatograph mass spectrometry data processing method according to claim 4, wherein the peak threshold is the intensity of the selected MS1 peak.

7. The chromatograph mass spectrometry data processing method according to claim 1, wherein the peak threshold is a value obtained by multiplying the intensity of the selected MS1 peak by a predetermined factor.

8. The chromatograph mass spectrometry data processing method according to claim 4, wherein the peak threshold is a value obtained by multiplying the intensity of the selected MS1 peak by a predetermined factor.

9. The chromatograph mass spectrometry data processing method according to claim 7, wherein the predetermined factor is in a range of 0.8 to 1.2.

10. The chromatograph mass spectrometry data processing method according to claim 8, wherein the predetermined factor is in a range of 0.8 to 1.2.

11. The chromatograph mass spectrometry data processing method according to claim 3, wherein the peak threshold is a value obtained by multiplying the intensity of the selected MS1 peak by a valence of an ion corresponding to the selected MS1 peak.

12. The chromatograph mass spectrometry data processing method according to claim 4, wherein the peak threshold is a value obtained by multiplying the intensity of the selected MS1 peak by a valence of an ion corresponding to the selected MS1 peak.

13. The chromatograph mass spectrometry data processing method according to claim 11, wherein a value predicted based on a type of a sample and a type of an ionization method for the sample is used as the valence of the ion corresponding to the selected MS1 peak.

14. The chromatograph mass spectrometry data processing method according to claim 12, wherein a value predicted based on a type of a sample and a type of an ionization method for the sample is used as the valence of the ion corresponding to the selected MS1 peak.

15. A chromatograph mass spectrometry data processing apparatus, comprising:
an input reception unit configured to receive an input of an intensity of one MS1 peak selected from one or a plurality of MS1 peaks appearing in an MS1 spectrum acquired by MS1 analysis, and an MS2 spectrum acquired by MS2 analysis using ions belonging to a mass-to-charge ratio range as precursor ions for a predetermined mass-to-charge ratio range including a mass-to-charge ratio corresponding to the selected one MS1 peak;
a peak threshold setting unit configured to set a peak threshold based on the intensity of the selected one MS1 peak; and
a determination unit configured to compare an intensity of an MS2 peak appearing in the MS2 spectrum with the peak threshold, and determine that the MS2 spectrum is a chimeric MS2 spectrum when there is an MS2 peak having an intensity greater than the peak threshold.
